(19) United States
(12) Patent Application Publication
(10) Pub. No.: US 2007/0133495 A1
(43) Pub. Date: Jun. 14, 2007

(54) TRANSMITTER AND TRANSMITTING METHOD OF CODE DIVISION MULTIPLEXING WIRELESS COMMUNICATION SYSTEM USING ON-OFF KEYING MODULATION SCHEME

(75) Inventors: Sang Yub Lee, Kyungki-Do (KR); Chang Soo Yang, Kyungki-Do (KR); Jeong Suk Lee, Kyungki-Do (KR); Wan Cheol Yang, Kyungki-Do (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/555,117

(22) Filed: Oct. 31, 2006

(30) Foreign Application Priority Data
Dec. 5, 2005 (KR) 10-2005-0117775

(51) Int. Cl. H04B 7/216

(52) U.S. Cl. 370/342; 370/320

(57) ABSTRACT

A transmitter and a transmitting method in a code division multiplexing (CDM) wireless communication system are provided. The transmitter includes a DC offset unit, a Barker code generating unit, a multiplier, a unipolar code generating unit, a Kronecker product unit, and a modulator. The DC offset unit transforms digital transmitting data to bipolar data, and the Barker code generating unit generates a Barker code. The multiplier multiplies the bipolar data with the Barker code and outputting the multiplying result, and the unipolar code generating unit generates a predetermined unipolar code. The Kronecker product unit multiplies the multiplying result from the multiplier and the unipolar code based on the Kronecker product, and outputs the result thereof, and the modulator modulates the output of the Kronecker produce unit through the On-Off keying modulation scheme.

### RELATED APPLICATION

The present application is based on, and claims priority from, Korean Application Number 2005-117775, filed Dec. 5, 2005, the disclosure of which is hereby incorporated by reference herein in its entirety.

### BACKGROUND OF THE INVENTION

1. Field of the Invention

The present invention relates to a transmitter and a transmitting method for wireless communication system using code division multiplexing (CDM), and more particularly, to a transmitter and a transmitting method using on-off keying (OOK) for improving auto correlation characteristics and cross correlation characteristic through the Kronecker product of a Barker code and a prime code in wireless communication system using CDM.

2. Description of the Related Art

In a wireless communication system using code division multiple (CDM) that dose not use an On-Off keying modulation scheme, a pseudo noise (PN) code is generally used for spreading a band. The PN code is used to restore data only when the synchronization is archived. Therefore, an asynchronous type system cannot use the PN code to restore the data. Especially, a code with superior orthorgonality must be used in order to accommodate a number of users, and the longer code has the better characteristics.

However, an ultra wide band (UWB) wireless communication system using CDM, which is used to form a piconet, uses a short code, for example, about 15 to 16 bits, for spreading the base-band digital data. Also, the UWB wireless communication system using CDM requires large auto-correlation value to improve the receiving performance of the band spread signal and requires the small cross correlation value to prevent the interference from the adjacent piconet. That is, the larger the autocorrelation value is, the better the autocorrelation characteristic becomes. Also, the smaller the cross correlation value is, the better the cross correlation characteristic becomes.

Conventionally, the UWB wireless communication system using CDM generally uses a Barker code or a CAZAC code which refers to constant amplitude zero au to correlation.

FIG. 1 is a block diagram illustrating a conventional wireless communication system using CDM using a Barker code.

Referring to FIG. 1, a conventional transmitter includes a DC offset unit 11 for transforming base-band digital transmitting data to bipolar signal, a Barker code generating unit 12 for generating a Barker code, a multiplier 11 for multiplying the generated Barker codes from the Barker code generating unit 12 and the output from the DC offset unit 11, and a modulator 14 for modulating the output signal of the multiplier 13 based on the On-Off keying modulation schemed.

Since the digital transmitting data is a unipolar signal formed of 0 and 1, the DC offset unit 11 transforms the unipolar signal to bipolar signals formed of −1 and 1. For example, the DC offset unit 11 transforms 0 to −1, and transforms 1 to 1. Meanwhile, the Barker code generating unit 12 creates a Barker code used to spread the band of the digital transmitting data. The multiplier 13 multiplies the bipolar signal outputted from the DC offset unit 11 and the Barker code created from the Barker code generating unit 12 to spread the band of the digital transmitting data. The band spread signal is modulated by the modulator based on On-Off Keying modulation scheme, and the modulated signal is transmitted to a channel through an antenna.

FIG. 2a and 2b is graphs showing the auto correlation and the cross correlation characteristics of a band spread signal using a Barker code. As shown in the graphs in FIG. 2a and 2b, the band spread signal using the Barker code has the large autocorrelation value and the large cross correlation value. Since the wireless communication system using CDM using a conventional Barker code has the large autocorrelation value and the large cross correlation value, the data receiving performance of the wireless communication system using CDM is degraded by the interference of the adjacent piconet.

Meanwhile, since the band spread signal using a CAZAC code forms a code through an imaginary part which expresses a phase characteristic which is not 1 or −1, the CAZAC code is not suitable for the On-Off keying modulation scheme.

Therefore, there is a demand for a transmitter and a transmitting method using a new code, which provide the superior autocorrelation characteristics while providing superior cross correlation characteristics to be applied to a plurality of piconets, and are suitable for On-Off keying modulation schemed.

### SUMMARY OF THE INVENTION

Accordingly, the present invention is directed to a transmitter and a transmitting method in a wireless communication system using CDM that substantially obviates one or more problems due to limitations and disadvantages of the related art.

An object of the present invention is to provide a transmitter and a transmitting method suitable for an On-Off keying modulation scheme for improving auto correlation characteristics and cross correlation characteristic by spreading digital data using a Barker code and multiplying a prime code with the band spared signal based on Kronecker product.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a transmitter of a CDM (code division multiplexing) wireless communication system using On-Off keying modulation scheme includes: a DC offset unit for transforming digital transmitting data to bipolar data; a Barker code generating unit for generating a Barker code; a multiplier for multiplying the bipolar data with the Barker code and outputting the multiplying result; a unipolar code generating unit for generating a predetermined unipolar code; a Kronecker product unit for multiplying the multiplying result from the multiplier and the unipolar code based on the Kronecker product, and outputting the result thereof; and a modulator for modulating the output of the Kronecker produce unit through the On-Off keying modulation scheme.

The unipolar code may be a prime code.

The modulator may modulate the output of the Kronecker product unit based on On-Off keying modulation scheme using a chaotic signal as a carrier signal.

The Barker code generated from the Barker code generating unit may be a four-bit Barker code, and the unipolar code generated from the unipolar code generating unit is four bit-unipolar code.

According to another aspect of the present invention, there is provided a transmitting method for a CDM (code division multiplexing) wireless communication system using On-Off keying modulation scheme, including the steps of: a) transforming digital transmitting data to bipolar data; b) multiplying the bipolar data with a predetermined Barker code; c) multiplying the multiplying result of the step b) and a predetermined unipolar code based on a Kronecker product; and d) modulating the multiplying result of the step c) through the On-Off keying modulation scheme.

The unipolar code may be a prime code.

In the step d), the multiplying result of the step c) may be modulated based on the On-Off keying modulation scheme using a chaotic signal as a carrier signal.

The Barker code may be a four-bit Barker code, and the unipolar code may be a four-bit unipolar code.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a conventional CDM wireless communication system using a Barker code;

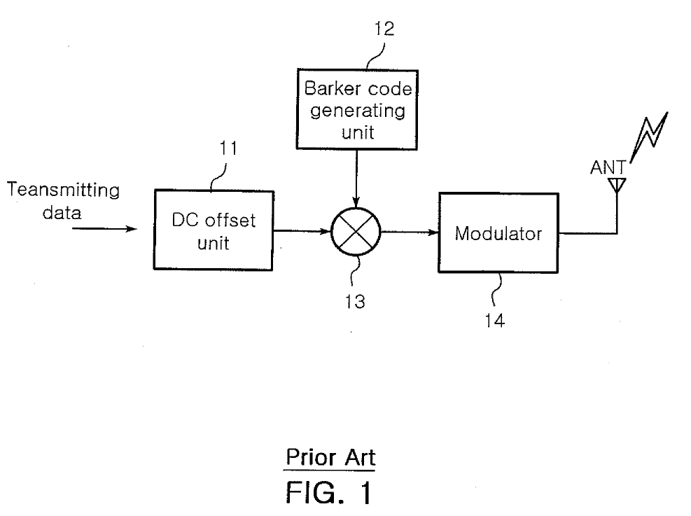

FIG. 2 is graphs for showing the auto correlation and the cross correlation characteristics of a band spread signal using a Barker code;

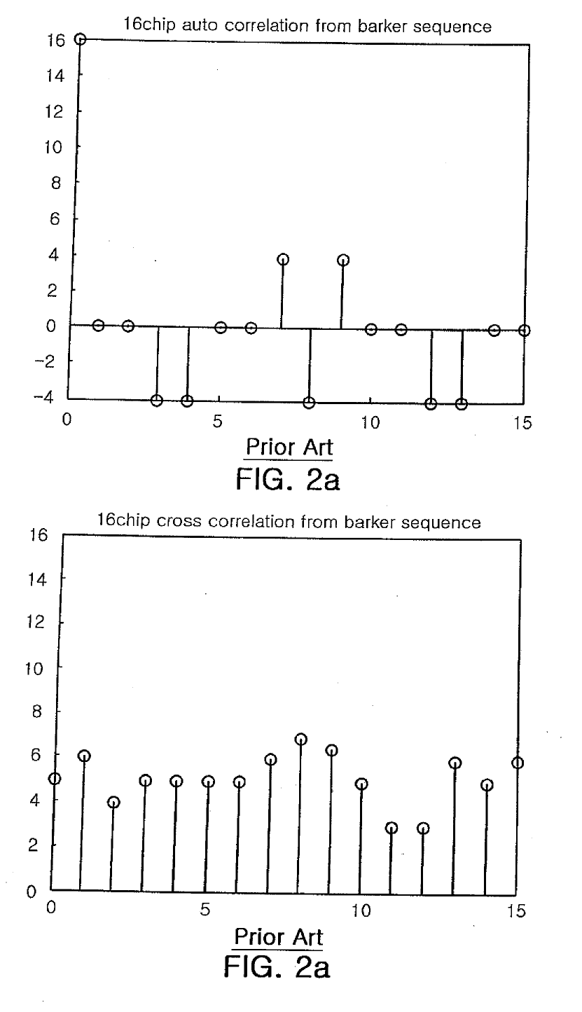

FIG. 3 is a block diagram illustrating a transmitter in a CDM wireless communication system using On-Off keying modulation scheme according to an embodiment of the present invention;

FIG. 4 is a block diagram illustrating a receiver for receiving a signal transmitted from a transmitter in a CDM wireless communication system using On-Off Keying according to an embodiment of the present invention;

FIG. 5 shows graphs a) and b) for showing auto correlation and cross correlation characteristics of band spread signal created from a transmitter according to an embodiment of the present invention; and

FIG. 6 is a graph comparing bit error rates (BER) between a band spread signal with a conventional Barker code, and a band spread signal created according to the present invention.

### DETAILED DESCRIPTION OF THE INVENTION

Reference will now be made in detail to the preferred embodiments of the present invention, examples of which are illustrated in the accompanying drawings.

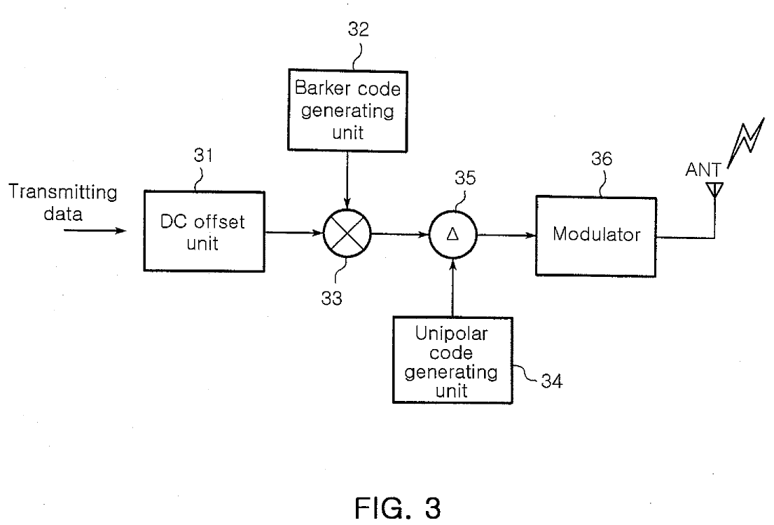

FIG. 3 is a block diagram illustrating a transmitter in a CDM (code division multiplexing) wireless communication system using On-Off keying modulation scheme according to an embodiment of the present invention.

Referring to FIG. 3, the transmitter according to the present embodiment includes a DC offset unit 31 for transforming digital transmitting data to bipolar data, a Barker code generating unit 32 for generating a Barker code, a multiplier 33 for multiplying the bipolar data and the Barker code, a unipolar code generating unit 34 for generating a predetermined unipolar code, a Kronecker product unit 35 for performing a Kronecker product on the output of the multiplier and the unipolar code, and a modulator 36 for modulating the output of the Kronecker product unit based on the On-Off Keying modulation.

The DC offset unit 31 transforms digital transmitting data to bipolar data. The digital transmitting data is the unipolar data formed on 0 and 1, and it is transformed to bipolar data to multiply it with the Barker code generated from the Barker code generating unit 32. For example, the digital transmitting data [1, 0, 1, 0] is transmitted to [1, −1, 1, −1] by the DC offset unit 31.

The Barker code generating unit 32 creates a predetermined baker code that is previously setup at a receiver that receives the digital transmitting data. The Barker code is a bipolar sequence. The Barker code generating unit 32 generates a short Barker code to be applied to the UWB CDM wireless communication system. It is preferable that the Barker code generating unit 32 may create a four bit Barker code because a final coding signal created through Kronecker product with the unipolar code is formed of about 15 to 16 bits.

The multiplier 33 multiplies the Barker code generated from the Barker code generating unit 32 and the digital transmitting data transformed to the bipolar data. For example, when the Barker code generating unit 32 generates a Barker code [−1, 1, 1, −1], the bipolar data transformed digital transmitting data 1 is transformed to a band spread code [−1, 1, 1, −1], and −1 is transformed to a band spread code [1, −1, −1, 1]. A step of multiplying a Barker code generated from the Barker code generating unit 32 with the bipolar transformed digital transmitting data by the multiplier 33 is referred to a first coding.

The unipolar code generating unit 34 creates a predetermined unipolar code that is previously setup at a receiver that received digital transmitting data similar to the Barker code generating unit 32. Preferably, the unipolar code is a prime code. The unipolar code generated from the unipolar code generating unit 34 is multiplied with the result of multiplying the bipolar data with the Barker code based on the Kronecker product. Since the signal generated from the Kronecker product becomes a final coded signal of a receiver according to the present invention and the signal must be formed of about 15 to 16 bits, it is preferable that the unipolar code generating unit 34 may generate a four-bit unipolar code when the Barker code generating unit 32 generates the four-bit Barker code.

The Kronecker product unit 35 multiplies the first coded signal from the multiplier and the unipolar code generated from the unipolar code generating unit 34 through the Kronecker product. Such a Kronecker product is referred to a second coding. If the unipolar code is a four bit code, the transmitter according to the present invention spreads the one bit of the digital transmitting data to four bit signals through the first coding using a four bit baker code, and spreads the four bit signal to a 16 bits spread signal through a second coding using four bit unipolar code. For example, if the unipolar code generating unit 34 generates a unipolar code [0, 1, 1, 1] and the multiplier 33 outputs a signal [−1, 1, 1, 1] as a result of the first coding, the Kronecker product unit 35 outputs [0, −1, −1, −1, 0, 1, 1, 1, 0, 1, 1, 1, 0, −1, −1, −1].

The modulator 36 modulates the second coded signal outputted from the Kronecker product unit 35 based on the On-Off Keying modulation scheme. It is preferable that the modulator 36 is a chaotic modulator that modulates the second coded signal through the On-Off keying modulation scheme using a chaotic signal as a carrier signal.

The chaotic signal is an aperiodic signal that does not have a phase and has ultra wide bandwidth characteristics. Since a typical periodic signal generally has a regular phase varying according to time, the typical periodic signal may be distorted or attenuated when the inverse phase reference signal is added. However, the chaotic signal dose not have a phase. Therefore, the data signal having information can be protected because the chaotic signal is not interfered although the reverse phase signal or the adjacent interference signal flows thereto. Also, the chaotic signal has superior energy efficiency, which has a regular size of the energy regardless of cycles in the ultra wide band.

In case of using the chaotic signal as a carrier wave as described above, it does not require additional coding such as time hopping due to small spike, and a transmitter and a receiver thereof can be simply embodied by employing On-Off keying scheme. Since the modulation scheme using the chaotic signal can control the chaotic signal through the small variation of system, a communication system with further improved power efficiency can be embodied. Furthermore, the chaotic signal can be used to modulate a signal with energy spectrum that is not lost through a wide band because the chaotic signal fundamentally has continuous-spectrum that spreads through a wide frequency band.

Such a chaotic modulator can be embodied by employing a chaotic modulation scheme introduced in Korean Patent Application No. 2005-77369 filed by the same applicant of the present invention, entitled “Transmitter using chaotic signal,” and filed on 23 Aug. 2005.

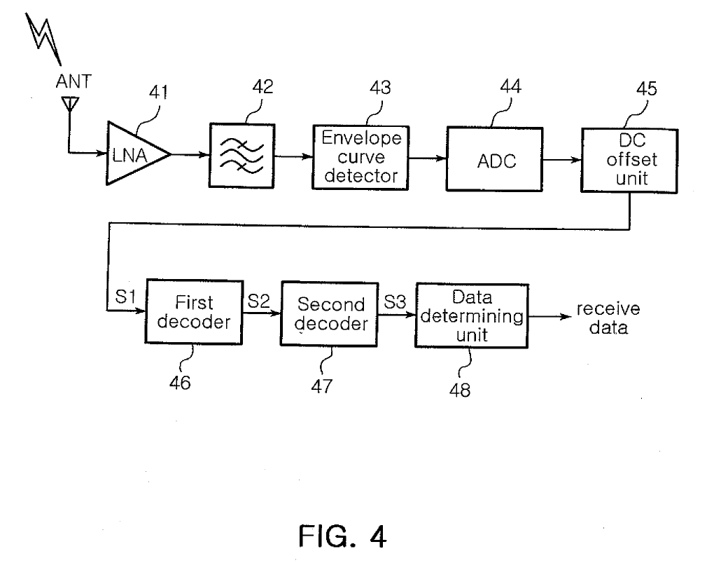

FIG. 4 is a block diagram illustrating a receiver for receiving a signal transmitted from a transmitter in a CDM wireless communication system using On-Off Keying according to an embodiment of the present invention.

Referring to FIG. 4, the receiver receives On-Off keying modulated band spread signal with the chaotic signal as a carrier signal, which is transmitted from the transmitter, through an antenna. Then, a low noise amplifier (LNA) 41 amplifies the received signal, and a band pass filter 42 passes a desired channel. Then, an envelope curve detector 43 detects the envelope curve of the chaotic modulate signal. Afterward, a D/A converter 44 converts the signal outputted from the envelop curve detector 43 to a clean digital signal, and a DC offset unit 45 transforms the digital signal to the bipolar signal S1.

The bipolar signal S1 is first-decoded at a first decoder 46. For example, the first decoder 46 divides the 16-bit bipolar signal into four groups of four bits, and multiplies each of the four groups with four bit Barker code so as to create a signal S2 formed of four values.

A second decoder 47 multiples the four values of the created signal S2 with four-bit unipolar code and adds each of the multiplying results. If the receiver uses a prime code to encode, the prime code is used instead of the four-bit unipolar code.

The second decoded value S3 outputted from the second decoder 47 inputs into the data determining unit 68. The data determining unit 68 outputs 1 if the input value S3 is larger than 0, or outputs 0 if the input value S3 is smaller than 0 so as to restore a digital transmitting signal which was transmitted from the transmitter.

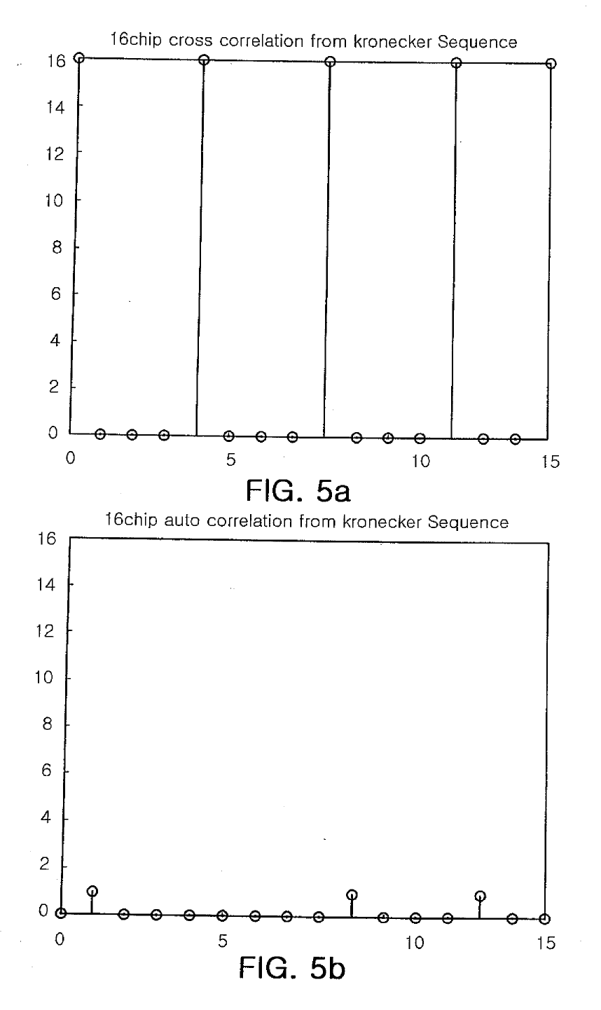

FIG. 5a and 5b are graphs for showing auto correlation and cross correlation characteristics of band spread signal created from a transmitter according to an embodiment of the present invention.

As shown in the graph of FIG. 5a, the band spread signal created from the transmitter according to the present embodiment has a high auto correlation value due to the Barker code characteristics. That is, the auto correlation characteristic is superior.

As shown in the graph of FIG. 5b, the band spread signal created from the transmitted according to the present embodiment has very small cross-correlation value by reducing the influence to other codes because the band spread signal is created through the Kronecker product with unipolar code or a prime code. The cross correlation characteristic thereof is superior.

As described above, the band spread signal created by the transmitter has not only superior auto correlation characteristic but also superior cross correlation characteristic. Therefore, the transmitter according tot he present embodiment can provide the superior communication performance when the transmitter is simultaneously applied into a plurality of Piconets.

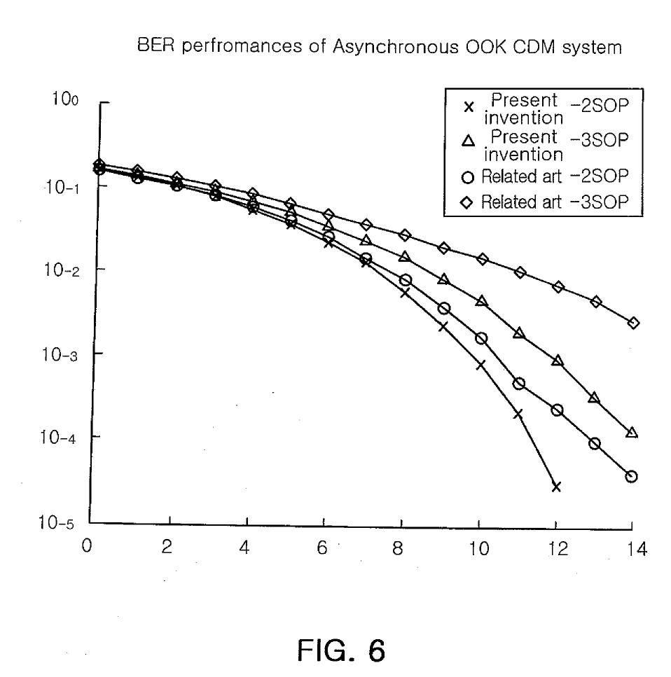

FIG. 6 is a graph comparing bit error rates (BER) between a band spread signal with a conventional Barker code, and a band spread signal created according to the present invention.

As shown in FIG. 6, the band spread signal created according to the present embodiment has a much lower BER than the conventional band spread signal created using the Barker code when the same number of piconets is operated. That is, the band spread signal according to the present embodiment has superior performance.

As described above, the transmitter and the transmitting method according to the present invention provide superior autocorrelation characteristics by using a Barker code and also provide superior cross correlation characteristics to be applied into the plurality of piconets using the Kronecker produce with a unipolar code or a prime code.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A transmitter of a CDM (code division multiplexing) wireless communication system using On-Off keying modulation scheme, the transmitter comprising:
a DC offset unit for transforming digital transmitting data to bipolar data;
a Barker code generating unit for generating a Barker code;
a multiplier for multiplying the bipolar data with the Barker code and outputting the multiplying result;
a unipolar code generating unit for generating a predetermined unipolar code;
a Kronecker product unit for multiplying the multiplying result from the multiplier and the unipolar code based on the Kronecker product, and outputting the result thereof; and
a modulator for modulating the output of the Kronecker produce unit through the On-Off keying modulation scheme.

2. The transmitter of claim 1, wherein the unipolar code is a prime code.

3. The transmitter of claim 1, wherein the modulator modulates the output of the Kronecker product unit based on On-Off keying modulation scheme using a chaotic signal as a carrier signal.

4. The transmitter of claim 1, wherein the Barker code generated from the Barker code generating unit is a four-bit Barker code, and the unipolar code generated from the unipolar code generating unit is four bit-unipolar code.

5. A transmitting method for a CDM (code division multiplexing) wireless communication system using On-Off keying modulation scheme, the transmitting method comprising the steps of:
a) transforming digital transmitting data to bipolar data;
b) multiplying the bipolar data with a predetermined Barker code;
c) multiplying the multiplying result of the step b) and a predetermined unipolar code based on a Kronecker product; and
d) modulating the multiplying result of the step c) through the On-Off keying modulation scheme.

6. The transmitting method of claim 5, wherein the unipolar code is a prime code.

7. The transmitting method of claim 5, wherein in the step d), the multiplying result of the step c) is modulated based on the On-Off keying modulation scheme using a chaotic signal as a carrier signal.

8. The transmitting method of claim 5, wherein the Barker code is a four-bit Barker code, and the unipolar code is a four-bit unipolar code.
